(19) United States
(12) Patent Application Publication
(10) Pub. No.: US 2011/0216536 A1
(43) Pub. Date: Sep. 8, 2011

(54) ILLUMINATION DEVICE

(75) Inventors: Tomokazu OKAZAKI, Kyoto (JP); Masaru IGAKI, Kyoto (JP); Hironobu KANEKO, Kyoto (JP)

(73) Assignee: ROHM CO., LTD., Kyoto (JP)

(21) Appl. No.: 13/041,664

(22) Filed: Mar. 7, 2011

(30) Foreign Application Priority Data
Mar. 8, 2010 (JP) 2010-050157

(51) Int. Cl. F21V 7/22; F21S 4/00; F21V 29/00

(52) U.S. Cl. 362/235; 362/249.02

(57) ABSTRACT

An illumination device that includes a plurality of LED chips and a heat-dissipating unit including a fan configured to ventilate air. The plurality of LED chips are cooled as heat generated in the plurality of LED chips is transferred to the air ventilated by the fan.

### CROSS-REFERENCE TO RELATED APPLICATIONS

This application is based upon and claims the benefit of priority from Japanese Patent Application No. 2010-050157, filed on Mar. 8, 2010, the entire contents of which are incorporated herein by reference.

### FIELD

Embodiments described herein relate generally to an illumination device, and particularly to an illumination device used as a spotlight, a floodlight or the like.

### BACKGROUND

An illumination device using an LED chip can be used as a light source of a spotlight or floodlight (see Japanese Patent Laid-Open Publication No. 2010-16003). The illumination device includes an LED chip, a reflector configured to reflect light from the LED chip, a power unit configured to supply power to the LED chip, and a case containing the power unit. In the illumination device, the LED chip generates heat when it emits light.

In some illumination devices, more current must be supplied to the LED chip to emit a brighter light. As the current supplied to the LED chip is increased, the heat generated by the LED chip is increased. Therefore, the temperature of the LED chip is increased. If the temperature of the LED chip is increased, the LED chip may break down. For this reason, the heat generated by the LED chip needs to be more quickly dissipated outside of the illumination device.

### SUMMARY

The present disclosure provides an illumination device that is capable of efficiently cooling a LED chip.

An illumination device according to one embodiment includes a plurality of LED chips and a heat-dissipating unit including a fan configured to ventilate air. The heat generated in the plurality of LED chips is transferred to the air ventilated by the fan and thus cooling the plurality of LED chips.

### BRIEF DESCRIPTION OF THE DRAWINGS

FIG. 1 is a side view of an illumination device according to an embodiment of the present disclosure.

FIG. 2 is a plane view of the illumination device according to the embodiment.

FIG. 3 is a schematic side sectional view of the illumination device that is taken along a III-III line of FIG. 2.

FIG. 4 is a decomposed schematic side sectional view of the illumination device according to the embodiment.

FIG. 5 is a schematic horizontal sectional view of the illumination device that is taken along a V-V line of FIG. 3.

FIG. 6 is a drawing showing an example of the illumination device in use.

FIG. 7 is a schematic side sectional view of an LED module.

FIG. 8 is a schematic plane view of a plurality of LED modules and a wiring substrate.

FIG. 9 is a schematic horizontal sectional view of the illumination device that is taken along an IX-IX line of FIG. 3.

FIG. 10 is a plane view showing a support plate.

### DETAILED DESCRIPTION

Other features and advantages of the present disclosure will become more apparent from the following detailed description with reference to the attached drawings.

Hereinafter, an embodiment of the present disclosure will be described specifically with reference to the drawings.

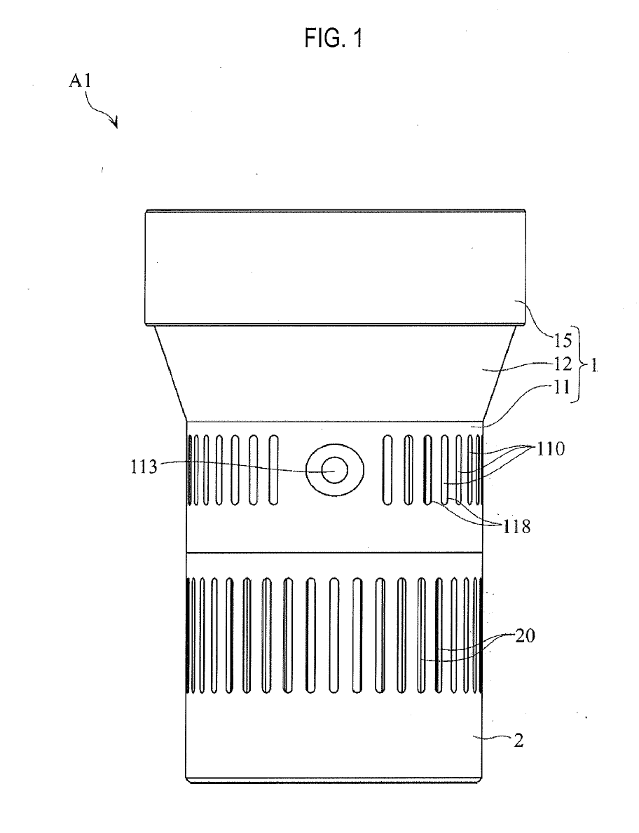

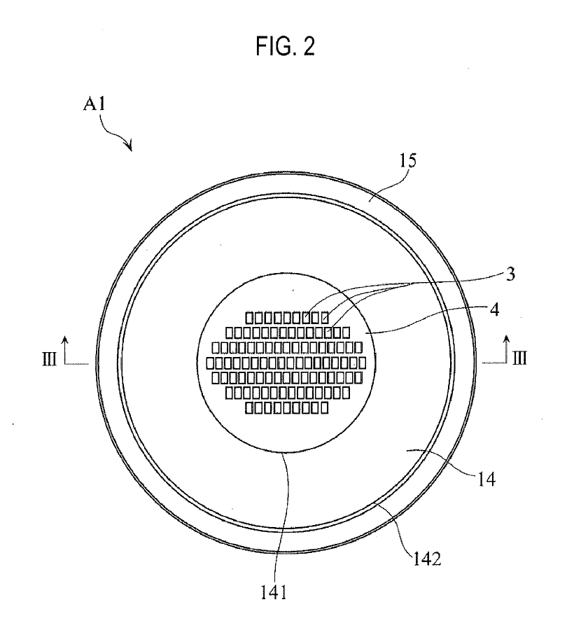

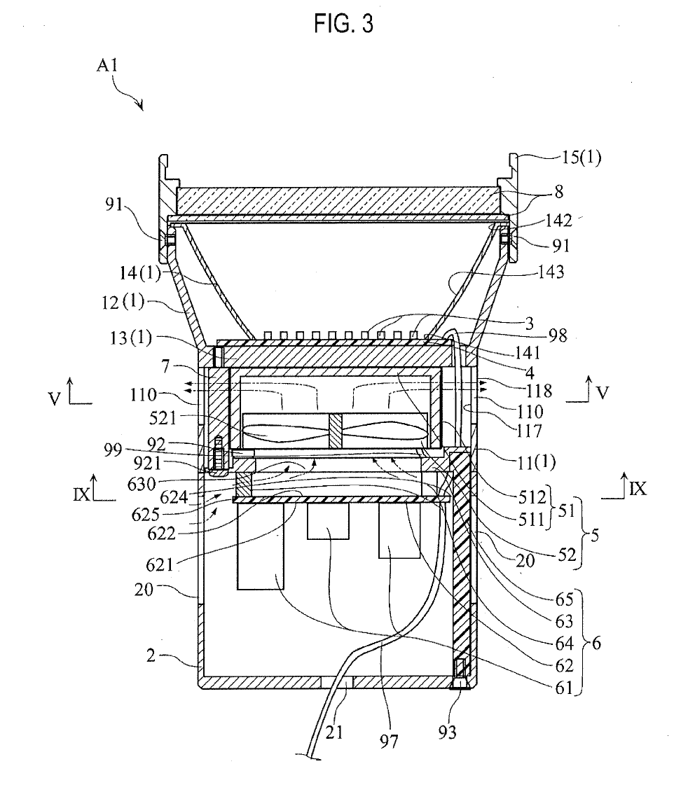

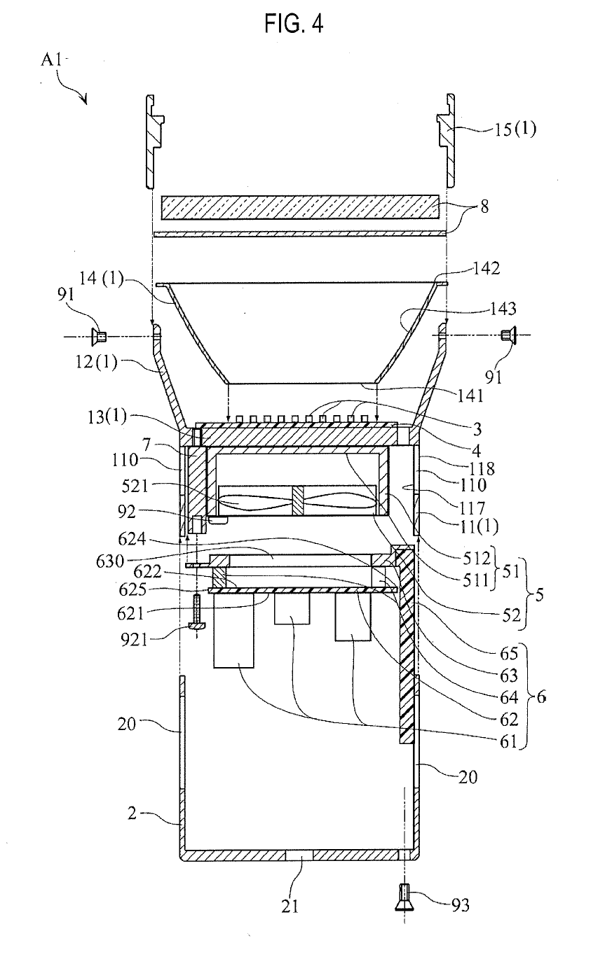

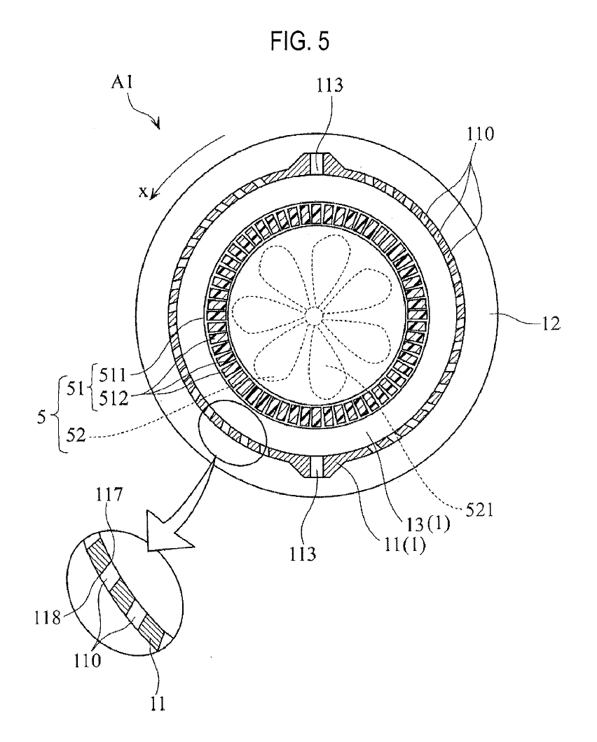

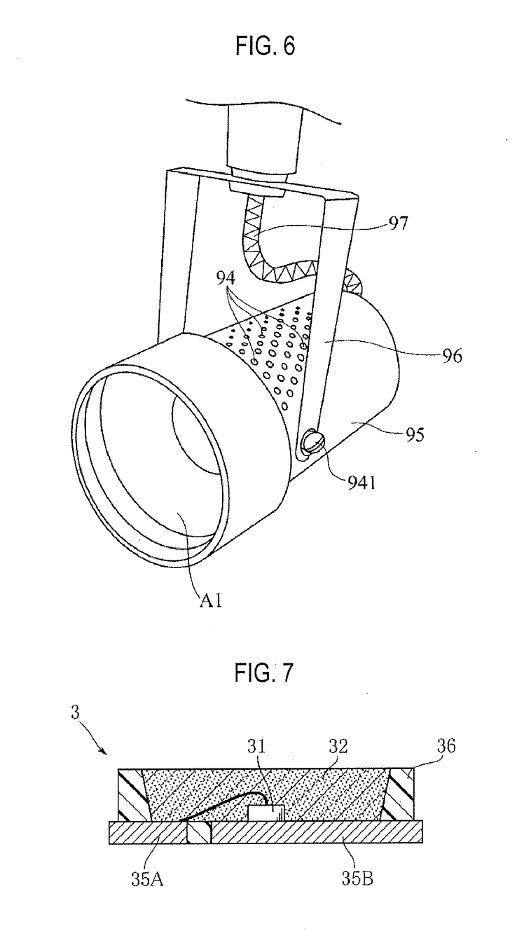

One example of one embodiment of the present disclosure will be described with reference to FIGS. 1 to 10. FIG. 1 is a side view of an illumination device according to the embodiment. FIG. 2 is a plane view of the illumination device according to the embodiment. FIG. 3 is a schematic side sectional view of the illumination device that is taken along a line of FIG. 2. FIG. 4 is a decomposed schematic side sectional view of the illumination device according to the embodiment. FIG. 5 is a schematic horizontal sectional view of the illumination device that is taken along a V-V line of FIG. 3. The illumination device A1 shown in the drawings is used, for example, as a floodlight or a spotlight in a theater or the like. FIG. 6 is a drawing showing an example of the illumination device in use. As shown in the drawing, the illumination device A1 is used, for example, in a state in which the illumination device A1 is enclosed by a cover 95 having a plurality of through holes 94. The illumination device A1 enclosed by the cover 95 and is supported by an arm 96. In the drawings, except for FIG. 6, the cover 95 is not shown.

The illumination device A1 as shown in FIGS. 1 to 5 has a cylindrical shape in which a diameter of the bottom is about 78 mm and a height is about 150 mm. The illumination device A1 has a first case 1, a second case 2, a plurality of LED modules 3, a wiring substrate 4, a heat-dissipating unit 5, a power unit 6, a spacer 7, a lens 8, and wirings 97 to 99.

FIG. 7 is a schematic side sectional view of the LED module 3.

As shown in FIG. 7, each of the plurality of LED modules 3 (as indicated in FIG. 3) includes an LED chip 31, a sealing resin 32, leads 35A and 35B, and a reflector 36. For example, each of the LED modules 3 has a width of about 4.0 mm, a length of about 2.0 mm, and a thickness of about 0.6 mm. As such, each of the LED modules 3 may be configured to have a small and also very thin structure.

Each of the leads 35A and 35B is, for example, a plate type member which is made of Cu—Ni alloy. Each of the leads 35A and 35B is used as a mounting terminal for surface-mounting the LED module 3. The reflector 36 is made of, for example, white resin.

The LED chip 31 is a light source of the LED module 3. The LED chip 31 emits, for example, visible light. The LED chip 31 is mounted on the lead 35B through, for example, a silver paste. The LED chip 31 is electrically connected to the lead 35B. Further, the LED chip 31 is electrically connected to the lead 35A through a wire. When a current is supplied to the LED chip 31, light is radiated from the LED chip 31. At the same time, heat is generated in the LED chip 31 (or in the LED module 3).

The sealing resin 32 protects the LED chip 31. The sealing resin 32 is made of, for example, epoxy resin which is transparent with respect to the light emitted from the LED chip 31. Alternatively, the sealing resin 32 is made of, for example, transparent resin containing fluorescent material which radiates light of a different wavelength by being excited by the light emitted from the LED chip 31. For example, when blue light from the LED chip 31 and yellow light from the fluorescent material contained in the sealing resin 32 are mixed, white light is radiated from the LED module 3.

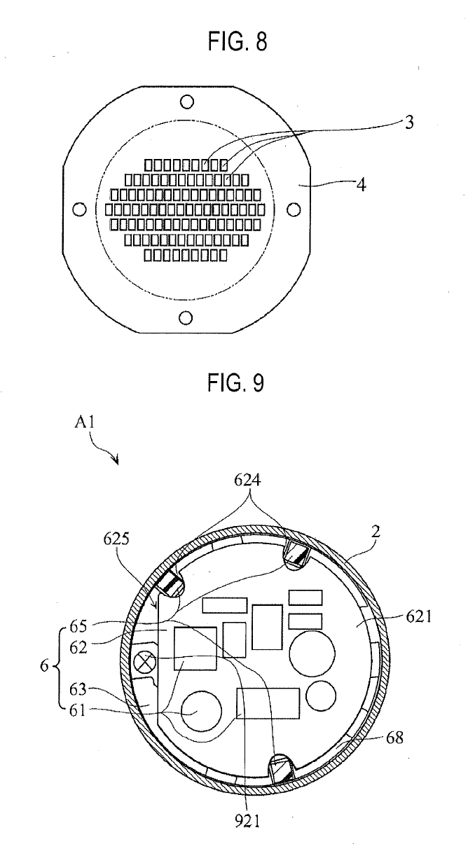

FIG. 8 is a schematic plane view of the plurality of LED modules 3 and the wiring substrate 4.

The wiring substrate 4 indicated in FIGS. 2 to 4 and FIG. 8 is made of, for example, glass epoxy resin. A filler of high thermal conductivity may be mixed in the glass epoxy resin, giving the resin high thermal conductivity. The plurality of LED modules 3 is disposed in the wiring substrate 4. For this reason, the heat generated by the LED module 3 is mostly transferred to the wiring substrate 4. On the wiring substrate 4, wiring patterns (not shown) for supplying power to the plurality of LED modules 3 are formed. As shown in FIG. 3, the wiring 98 is connected to such wiring patterns.

As shown in FIG. 8, the plurality of LED modules 3 on the wiring substrate 4 is disposed in a circular region which has a diameter of about 50 mm to 60 mm. In an embodiment, the number of the plurality of LED modules 3 is 84. Each of the LED modules 3 is disposed so that a longitudinal direction of the LED module 3 is parallel to a vertical direction of FIG. 8. The adjacent LED modules 3 arranged in a horizontal direction of FIG. 8 are disposed so that short edges of the adjacent LED modules 3 are aligned on a straight line. Moreover, an LED module group consisting of the plural LED modules 3 arranged in the horizontal direction of FIG. 8 is disposed in a stepped shape in a vertical direction of the same drawing. Furthermore, the plurality of LED modules 3 may be alternately disposed or arranged according to any other pattern in a vertical or horizontal direction. With the configuration as described above, the directionality of the light emitted from the LED modules 3 is averaged, which makes light radiated from the illumination device A1 more uniform.

The first case 1 as shown in FIGS. 1 to 5 is made of, for example, aluminum. The first case 1 includes a columnar part 11, a taper part 12, a partition plate 13, a reflector 14, and a holding part 15. The columnar part 11, the taper part 12, and the partition plate 13 may be formed as an integral mold product. As shown in FIG. 1, FIG. 3, and FIG. 4, the columnar part 11 is a columnar member, whose cross section has a circular shape, and is extended in a vertical direction of the drawings (a direction of thickness of the wiring substrate 4). A sectional shape of the columnar part 11 is not limited to the circular shape, and may have a polygonal shape. A plurality of through holes 110 and a pair of screw holes 113 are formed in the columnar part 11. As shown in FIG. 1, each of the through holes 110 has an elongated shape. It is possible for air to flow between the inside and the outside of the columnar part 11 through each through hole 110. The through holes 110 in the present embodiment serve as exhaust holes which dissipate the heated air outside of the columnar part 11. Through each of the screw holes 113, a screw 941 is inserted for connecting the illumination device A1 to an arm 96, as shown in FIG. 6.

In addition, as shown in FIG. 1, FIG. 3, and FIG. 5, the columnar part 11 has an internal edge 117 which contains one end of each through hole 110 and an external edge 118 which contains the other end of each through hole 110. Each of the internal edges 117 and external edges 118 has an elongated shape. As shown in FIG. 5, in the present embodiment, each through hole 110 is formed so that the external edge 118 is angled with respect to the internal edge 117 in a peripheral direction x of the columnar part 11 (e.g., a counter-clockwise direction in FIG. 5).

The taper part, 12 as shown in FIG. 1 and FIG. 3, is gradually broadened toward an upper direction of FIG. 3. The taper part 12 is connected with the columnar part 11. The partition plate 13 is a circular plate provided to be perpendicular to a vertical direction of FIG. 3. The partition plate 13 is disposed to partition a space surrounded by the columnar part 11 and a space surrounded by the taper part 12. The wiring plate 4 is disposed on the partition plate 11.

The reflector 14 as shown in FIGS. 2 to 4 has an opening 141 and an opening 142. The reflector 14 has a shape which is gradually broadened toward the upper direction of FIG. 3 and also has a reflective surface 143 for reflecting the light emitted from the LED module 3. The light radiated from the LED module 3 may progress to the opening 142 through the opening 141. Alternatively, the light radiated from the LED module 3 may pass through the opening 141, reflect on the reflective surface 143 and then progress to the opening 142.

The holding part 15 as shown in FIGS. 1 to 4 is attached to an upper end of the taper part 12 by using, for example, a screw 91 (see FIG. 3). The reflector 14 and a transparent lens 8 are inserted and fixed between the holding part 15 and the taper part 12.

As shown in FIGS. 1 and 3, the second case 2 is a columnar member which is extended in a vertical direction of FIGS. 1 and 3 and has a circular cross section. A sectional shape of the second case 2 is not limited to a circular shape, but may be a polygonal shape. A plurality of through holes 20 and a wiring insertion hole 21 are formed in the second case 2. As shown in FIG. 1, each of the through holes 20 has an elongated shape. Air may flow between the inside and the outside of the second case 2 through each through hole 20. Each of the through holes 20 in the present embodiment is an intake hole configured to allow air to flow inside of the second case 2.

The heat-dissipating unit 5, as shown in FIGS. 3 to 5, includes a heat sink 51 and a fan 52. The heat-dissipating unit 5 dissipates the heat generated in the LED module 3 to the outside of the illumination device A1 efficiently. The heat-dissipating unit 5 is accommodated in the columnar part 11 and is also surrounded by the columnar part 11. The heat-dissipating unit 5 faces the through holes 110 formed in the columnar part 11. The wiring substrate 4 is disposed between the heat-dissipating unit 5 and the plurality of LED modules 3.

The heat sink 51 is made of a material having high thermal conductivity, for example, aluminum, etc. The heat sink 51 is disposed on the partition plate 13 so that it is in contact with the partition plate 13. For this reason, the heat generated in the LED module 3 is easily transferred to the heat sink 51 through the wiring substrate 4 and the partition plate 13.

As shown in FIGS. 3 to 5, the heat sink 51 has a base part 511 and a plurality of fins 512. The base part 511 has a circular plate shape. The base plate 511 is fixed to the partition plate 13 so that it is in contact with the partition plate 13. Each of the fins 512 has a rod shape and the plurality of fins 512 is vertically provided with respect to the base part 511 with gaps between each of the fins 512. As shown in FIG. 5, the plurality of fins 512 are arranged in a circular shape. Each fin 512 enhances a radiation effect of the heat sink 51 by increasing a surface area of the heat sink 51.

The fan 52 has a plurality of propellers 521 which have a rotation axis extended in a vertical direction of FIG. 3. The fan 52 ventilates air by rotating the plurality of propellers 521. The fan 52 is fixed to the heat sink 51 by using, for example, a screw (not shown). Direction of rotation of the plurality of propellers 521 is identical to the peripheral direction x of the columnar part 11 (see FIG. 5). As shown in FIG. 5, the fan 52 is disposed to be surrounded by the plurality of fins 512. In the present embodiment, the fan 52 transfers air toward the heat sink 51. More specifically, the fan 52 transfers the air toward the base part 511. The air transferred toward the base part 511 from the fan 52 arrives at the base part 511 and flows out through gaps among the plurality of fins 512. The heat-dissipating unit 5 is fixed to the partition plate 13 by a screw 92 in a vertical direction of FIGS. 3 and 4. The wiring 99 is connected to the fan 52.

As shown in FIGS. 3 and 4, the spacer 7 is a rod type member which is made of, for example, metal and is vertically arranged and fixed to the partition plate 13. The spacer 7 is not shown in FIG. 5. In the vertical direction of FIG. 3, a size of each spacer 7 is larger than a size of the heat-dissipating unit 5. The number of spacers in the illumination device A1 may be one or plural.

The power unit 6 as shown in FIGS. 3 and 4 includes a plurality of electronic components 61, a power substrate 62, a support plate 63, a plurality of spacers 64, and a plurality of spacers 65 (only one of which is indicated in FIGS. 3 and 4). The power unit 6 is accommodated in the second case 2. The power unit 6 is aligned with the through holes 20 formed in the second case 2. The electronic components 61 serve as a power circuit for supplying power to the plurality of LED modules 3. The power is supplied to each LED module 3 through the wiring 98. The power circuit may, for example, convert a commercial AC 100V power into a DC 24V power. The power circuit also supplies power to the fan 52. The power is supplied to the fan 52 through the wiring 99.

FIG. 9 is a schematic horizontal sectional view of the illumination device which is taken along an IX-IX line of FIG. 3.

The power substrate 62 as shown in FIGS. 3, 4 and 9 is a circular plate and is made of, for example, glass epoxy resin. The power substrate 62 is disposed to be approximately parallel to the partition plate 13 and the wiring substrate 4. As shown in FIG. 9, a diameter of a circle which is an external shape of the power substrate 62 is shorter than an inner diameter of the second case 2 of the columnar shape. For this reason, a narrow gap 68 is formed between the second case 2 and the power substrate 62. Thus, air inducted into the second case 2 through the through holes 20 is drawn to the fan 52 through the gap 68. The power substrate 62 has a first surface 621 facing away from the wiring substrate 4 and a second surface 622 opposite to the first surface 621. The plurality of electronic components 61 are disposed on the first surface 621. Wiring patterns (not shown) composing the power circuit are formed on the first surface 621 and the second surface 622. Moreover, the wiring 97 for receiving the power from outside of the illumination device A1 is connected to the power circuit. The wiring 97 is guided from outside of the illumination device A1 to the inside thereof through the wiring insertion hole 21 formed in the second case 2.

As shown in FIG. 9, the power substrate 62 may have an approximately circular shape. On the power substrate 62, three semicircular recess portions 624 and a cutout 625 for easily inserting a screw 921 into the support plate 63 are formed. In FIG. 4, while the recess portions 624 and the cutout 625 are indicated together in one drawing for convenience of understanding, the positional relation between the recess portions 624 and the cutout 625 as shown in FIG. 4 may be different from the positional relation between the recess portions 624 and the cutout 625 as shown in FIG. 9.

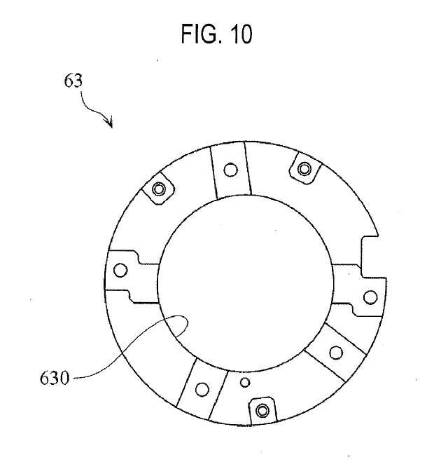

FIG. 10 is a plane view showing the support plate 63. The support plate 63 as shown in FIGS. 3, 4 and 10 is a circular ring shape in which an opening 630 is formed. The support plate 63 is made of, for example, aluminum. The support plate 63 is not limited to a circular ring shape, but may be formed as a plate type in which a plurality of openings are formed. As shown in FIG. 3, the support plate 63 is disposed to be separated from the power substrate 62. The opening 630 formed in the support plate 63 faces the heat-dissipating unit 5 (e.g., the fan 52 in the present embodiment). The second surface 622 of the power substrate 62 opposes the heat-dissipating unit 5 (e.g., the fan 52 in the present embodiment) through the opening 630 formed in the support plate 63.

The spacer 64 as shown in FIGS. 3 and 4 is made of, for example, resin. The spacer 64 separates the power substrate 62 from the support plate 63. The spacer 64 is fixed to the support plate 63 and the power substrate 62. As the power substrate 62 is separated from the support plate 63, electric insulation between the power substrate 62 and the support plate 63 is secured. Furthermore, as the power substrate 62 is separated from the support plate 63, air may easily flow through the opening 630 formed in the support plate 63 from an edge of the power substrate 62.

The plurality of spacers 65 have a rod shape, and are fixed to the support plate 63. For that reason, as shown in FIG. 4, the power unit is integrally fixed as one body. As described above, the support plate 63 is fixed to the spacer 7 which is fixed to the partition plate 13 (the first case 1) by using the screw 921. Therefore, the power unit 6 is fixed to the first case 1. Each of the spacers 65 is extended from the support plate 63 to a lower side of FIG. 3 through the recess portions 624 formed in the power substrate 62. A screw hole (not shown) is formed in a lower end of each spacer 65 of FIG. 3. A screw 93 is inserted into the screw hole from outside of the second case 2, and the second case 2 is fixed to the power unit 6.

Hereinafter, the operation of the illumination device A1 will be described more specifically with reference to FIG. 3.

First, the LED chip 31 emits light when power is supplied from the power circuit. The LED chip 31 (or LED module 3) generates heat when the LED chip 31 (or LED module 3) emits light. The heat generated in the LED module 3 is transferred to the heat sink 51 through the wiring substrate 4 and the partition plate 13.

In the meantime, while the LED module 3 emits light, the fan 52 is driven. If the fan 52 is driven, the air outside the illumination device A1 is drawn into the second case 2 through the through holes 20. The air drawn into the second case 2 flows to the fan 52 through a space between the power substrate 62 and the support plate 63, and the opening 630 formed in the support plate 63. Alternately, the air drawn into the second case 2 flows to the fan 52 through the gap 68 between the power substrate 62 and the second case 2, the space between the power substrate 62 and the support plate 63, and the opening 630 formed in the support plate 63.

Further, the fan 52 transfers air towards the base part 511. The air transferred towards the base part 511 from the fan 52 arrives at the base part 511 and then flows through the gaps among the plurality of fins 512. The air flowing through the gaps among the plurality of fins 512 cools the heat radiating from the plurality of fins 512. Further, air with a temperature higher than the temperature when drawn through the through holes 20 is discharged from the through holes 110. In this manner, the heat generated in the LED module 3 is transferred to the air that flows from the fan 52 and then is radiated outside of the illumination device A1 through the wiring substrate 4, the partition plate 13, and the heat sink 51.

The operation of the illumination device A1 will be described.

In the illumination device A1, the heat generated in the LED chip 31 (LED module 3) is transferred to the air that flows from the fan 52 and then is radiated outside of the illumination device A1. This configuration is suitable to efficiently cool the LED chip 31 (or LED module 3).

In the illumination device A1, as shown in FIG. 5, the plurality of fins 512 are disposed to surround the fan 52. For this reason, it is possible for the air that flows from the fan 52 to pass through the gaps among the plurality of fins 512 and to be discharged through a large range of the peripheral direction of the columnar part 11. This configuration is suitable to quickly exhaust the air (which cools the heat of the fins 512) outside of the illumination device A1.

In the illumination device A1, the second surface 622 of the power substrate 62 has a portion opposite the heat-dissipating unit 5 (fan 52 in the present embodiment). The second surface 622 is separated from the heat-dissipating unit 5. In this configuration, air may flow in a space between the second surface 622 and the heat-dissipating unit 5. Thus, it is possible to prevent air from flowing in the circumference of the plurality of electronic components 61 disposed on the first surface 621 opposite to the second surface 622. Accordingly, it is possible to prevent dust contained in air from being attached to the plurality of electronic components 61.

In the illumination device A1, the spacer 64 separates the power substrate 62 and the support plate 63. In addition, the opening 630 is formed on the support plate 63, and the second surface 622 opposes the heat-dissipating unit 5 through the opening 630. In this configuration, air may flow between the power substrate 62 and the support plate 63 and then pass through the opening 630. Consequently, it is possible to suitably secure the air to flow to the fan 52.

Moreover, in the illumination device A1, the outer air of the illumination device A1 is drawn from the through holes 20 which are aligned with the power unit 6, and the air used to cool the heat of the heat sink 51 and having a high temperature is emitted from the through holes 110 which are aligned with the heat-dissipating unit 5. If a direction of air flow is opposite to the present embodiment, the air with a high temperature flows around the power unit 6. On the other hand, in the present embodiment, the air with a temperature that is nearly identical to a temperature of the outer air of the illumination device A1 flows around the power unit 6. This configuration is suitable to prevent the electronic components 61 or the power substrate 62 in the power unit 6 from being damaged by heat.

As shown in FIG. 5, each through hole 110 is formed so that the external edge 118 is shifted with respect to the internal edge 117 in the peripheral direction x of the columnar part 11. Further, a rotating direction of the plurality of propellers 521 is in the peripheral direction x of the columnar part 11. With this configuration, air that flows from the fan 52 by the rotation of the propellers 521 passes easily through the through holes 110. Thus, air that flows from the fan 52 to cool the heat sink 51 is quickly ventilated outside of the illumination device A1.

The scope of the present disclosure is not limited to the embodiment described above. It is possible to modify the design of the detailed configuration of each component of the present disclosure. For example, the heat-dissipating unit may adopt a configuration for drawing air from a left side of FIG. 3 and discharging the air to the right side of FIG. 3. In addition, it is also possible to adopt a configuration in which a space where the power unit 6 is disposed and a space where the heat-dissipating unit 5 is disposed are separated so that air does not flow around the electronic components 61 or the power substrate 62. Further, the illumination device A1 may have a single first through hole 110 and a single second through hole 20.

A member which helps heat conduction such as silicon oil or silicon resin may be interposed between the partition plate 13 and the wiring substrate 4. With this configuration, heat may be easily transferred from the wiring substrate 4 to the partition plate 13. If a wiring on the wiring substrate 4 has uneven portions or windings, the wiring plate 4 and the partition plate 13 may not be completely adhered to each other. In this case, if the member which helps heat conduction is interposed between the partition plate 13 and the wiring substrate 4, the heat may be efficiently transferred from the wiring substrate 4 to the partition plate 13.

In the same manner, the member which helps heat conduction such as silicon oil or silicon resin may be interposed between the partition plate 13 and the heat-dissipating plate 51. With this configuration, heat may be easily transferred from the partition plate 13 to the heat-dissipating unit 51.

Each through hole 110 may be inclined in the peripheral direction x so that the inside of the columnar part 11 cannot be seen from the outside of the columnar part 11. From a design perspective, it may be advantageous in some embodiments to form each through hole 110 in the above-described manner since the heat-dissipating unit 5 cannot be seen from outside of the columnar part 11. In addition, even if impurities such as dust or the like fall on the columnar part 11 while the illumination device A1 is not being operated, the above configuration prevents the impurities from entering the columnar part 11. Also, because air is discharged from the through holes 110 while the illumination device A1 is being operated, the impurities gathered near the through holes 110 do not enter the columnar part 11 and are scattered away from the columnar part 11. Furthermore, if an object negligently falls over the through holes 110 while the illumination device A1 is being operated, the above configuration prevents the object from contacting the fan 52 accommodated in the columnar part 11.

If the plurality of fins 512 are inclined and an inclination direction of the plurality of fins 512 is identical to an inclination direction of the through hole 110, an emission efficiency of the air that flows from the fan 52 does not degrade.

While certain embodiments have been described, these embodiments have been presented by way of example only, and are not intended to limit the scope of the inventions. Indeed, the novel device described herein may be embodied in a variety of other forms; furthermore, various omissions, substitutions and changes in the form of the embodiments described herein may be made without departing from the spirit of the inventions. The accompanying claims and their equivalents are intended to cover such forms or modifications which would fall within the scope and spirit of the inventions.

1. An illumination device, comprising:
a plurality of LED chips; and
a heat-dissipating unit including a fan configured to ventilate air,
wherein the plurality of the LED chips are cooled by transferring heat generated by the plurality of LED chips to the air ventilated by the fan.

2. The illumination device of claim 1, further comprising a wiring substrate on which at least one of the plurality of LED chips is disposed, wherein the wiring substrate is disposed between the plurality of LED chips and the heat-dissipating unit.

3. The illumination device of claim 2, further comprising a first case configured to accommodate the heat-dissipating unit, the first case having one or more through holes.

4. The illumination device of claim 3, wherein the first case comprises a columnar part, extended in a thickness direction of the wiring substrate, which surrounds the heat-dissipating unit and wherein the one or more through holes are formed in the columnar part.

5. The illumination device of claim 4, wherein the heat-dissipating unit further comprises a heat sink to which the heat generated by the plurality of LED chips is transferred.

6. The illumination device of claim 5, wherein the heat sink has a plurality of fins facing the wiring substrate with gaps among the plurality of fins, and wherein the fan transfers the heated air to the gaps among the plurality of the fins.

7. The illumination device of claim 6, wherein the plurality of fins encircle the fan when viewed from the direction of the wiring substrate.

8. The illumination device of claim 7, further comprising a power unit which comprises a plurality of electronic components including a power circuit configured to supply power to the plurality of LED chips, and a power substrate on which the plurality of electronic components are disposed, wherein the heat-dissipating unit is disposed between the power unit and the wiring substrate.

9. The illumination device of claim 8, wherein the power substrate comprises a first surface facing the heat-dissipating unit and a second surface opposite to the first surface, and wherein the plurality of electronic components are disposed on the first surface facing the heat-dissipating unit.

10. The illumination device of claim 9, wherein the power unit further comprises a support plate provided to be separated from the power substrate, in which an opening is formed, and a spacer configured to maintain separation of the power substrate and the support plate, and wherein the second surface opposes the heat-dissipating unit through the opening.

11. The illumination device of claim 4, wherein the fan includes a propeller configured to rotate around an axis provided parallel to the thickness direction of the wiring substrate; and wherein the columnar part has an internal edge, which is one end of each of the one or more through holes and faces the heat-dissipating unit, and an external edge, which is the other end of each of the one or more through holes, and wherein each of the one or more through holes is configured so that the external edge is shifted with respect to the internal edge in a rotation direction of the propeller.

12. The illumination device of claim 11, wherein the first case is gradually broadened in a direction away from the heat-dissipating unit to the wiring substrate, and has a reflective surface configured to reflect light emitted from the plurality of LED chips.

13. The illumination device of claim 10, further comprising a second case configured to accommodate the power unit.

14. The illumination device of claim 13, wherein one or more through holes are formed in the second case.
